(19) United States
(12) Patent Application Publication
(10) Pub. No.: US 2006/0016224 A1
(43) Pub. Date: Jan. 26, 2006

(54) Reaction chamber and method for preparing preforms for optical fibers

(76) Inventors: Gilles Fonteneau, Nouvoitou (FR); Catherine Boussard-Pledel, Betton (FR); David Le Coq, Plaine Haute (FR)

Correspondence Address: HUTCHISON & MASON PLLC, PO BOX 31686, RALEIGH, NC, 27612, US

(21) Appl. No.: 10/518,820

(22) PCT Filed: Jun. 12, 2003
(86) PCT No.: PCT/EP03/50223

§ 371 Date: Jun. 23, 2005

(30) Foreign Application Priority Data
Jun. 21, 2002 (FR) 0207732

(51) Int. Cl. C03B 37/018

(52) U.S. Cl. 65/405; 65/424; 65/502

(57) ABSTRACT

The invention concerns a reaction chamber comprising a first container (1), a second container (4) connected to a conduit (6), an outer tube (3) emerging into the container (1), an outer tube (8) emerging into the conduit. The container (1) is designed to receive a sleeve glass, and the container (4) a core glass for optical fiber. The method for using said chamber, after vacuum sealing in (3a) and (8a), and heating the chamber at a sufficient temperature for melting the glasses, the chamber being in the position represented with the tube (3) in vertical position, consists: in a 180° anti-clockwise rotation about an axis perpendicular to the figure. The sleeve glass flows into the tube (3) while the core glass remains confined in the container (4); cooling the tube (3), then returning to the original position; part of the sleeve glass, maintained in liquid form in the center of the tube (3), drops into the container (1); carrying out another 180°, rotation, but clockwise. The core glass flows into the conduit (6) and drops by gravity into the empty central part of the tube (3), while the sleeve glass which has dropped again into the tube (3) and has cooled, remains congealed on the wall of the container (1). The invention thus enables preparation, in a vacuum sealed chamber containing the two glasses, a preform for optical fiber.

The present invention relates to a reaction chamber, in particular for fabricating a preform for double index optical fibers.

It is known that double index optical fibers can be obtained in particular from a preform manufactured beforehand. This preform consists of two glasses: a core glass and a cladding glass, the refractive index of which is less than that of the core glass.

One of the difficulties in the production of double index preforms is that contamination of each of the glasses by the other glass or by external contaminants should be avoided.

To do so, it would be necessary to produce the preform in a sealed evacuated chamber after introducing the two glasses into the chamber, while operating so that they cannot be in contact with each other except at the time when the preform is actually being produced.

There are several methods for obtaining double index preforms. For example, a rotational casting method could be adopted: a molten glass is poured into a cylindrical mold which is rotated rapidly in order to produce the cladding tube, into which the core glass is then poured.

According to the so-called build-in casting method, a molten cladding glass is poured into a cylindrical mold which is inverted rapidly so as to obtain a tube, into which the molten core glass is poured. The cladding glass can also be poured around a rod of core glass (the so-called cladding over core method). Other techniques operate by suction at the lower end of the mold. It is also possible to use a technique of injecting the core glass (CIT standing for core injection technique) which consists in fabricating a cladding glass by rotational casting then immersing the lower part of the tube in a bath containing the molten core glass, while applying a pressure difference between the surface of the bath and the interior of the tube.

The methods described above make it possible to obtain preforms which can be used in the preparation of multimode fibers (the core diameter of which is relatively large).

In order to obtain single-mode fibers (the core diameter of which is relatively small, for example less than one fifth of the cladding diameter), it is possible to start with preforms obtained either by chemical vapor deposition (CVD) methods or the modified CVD method, or by the so-called rod in tube method (a rod of core glass is put inside a cladding tube, and together they are then drawn into a fiber), or alternatively by the drawing-sleeving technique (a prefabricated preform is drawn then sleeved in a cladding glass tube, which is then shrunk either before the fiber pulling or during the fiber pulling).

All these methods therefore require the prefabrication of preforms.

Among all the methods of fabricating preforms which have been explained above, none is carried out in a sealed evacuated chamber containing the two glasses of different indices. Conversely, the present invention allows such production by virtue of a chamber with a special design.

The present invention therefore relates to a reaction chamber comprising:
a first container consisting essentially of a wall delimiting a volume which is substantially closed, apart from at least one first orifice formed in said wall,
a second container consisting essentially of a wall delimiting a volume which is substantially closed, apart from a second orifice connecting the second container to a first end of a conduit having an open second end,
   in which:
said first and second containers are integral,
said second container and said conduit are integral,
said open second end is inside the first container,
   said chamber being capable of occupying two positions, namely
a first position in which said first orifice is in an upper position relative to the other parts of the first container, and said second orifice is in a lower position relative to the other parts of the second container, and
a second position in which said first orifice is in a lower position relative to the other parts of the first container, said second orifice being in an upper position relative to the other parts of the second container, and said open end of the conduit is aligned with and at a distance from said first orifice, and the configuration of said chamber being such that when the chamber is rotated in a first predetermined direction from said first position to said second position, any liquid contained in said second container remains in the second container without being able to flow through said conduit to said open end, and when the chamber is rotated in a second predetermined direction, from said first position to said second position, any liquid contained in said second container flows through said conduit and reaches said open end.

In particular embodiments, the reaction chamber of the invention may also have the following features, taken individually or optionally in combination:
said second container and the conduit are inside the first container.
said conduit has at least one bend; for example, the conduit comprises a system of two bends in the shape of a Z; in a particular embodiment, said conduit comprises a first part from the orifice of the second container to a first bend at a distance from the second orifice, a second part from the first bend to a second bend, then a third part from the second bend to the open end, the conduit being for example constructed so that in said first position, said first bend occupies an upper position relative to the second orifice and said second end occupies a lower position relative to said first bend;
according to a particular embodiment, the branches of the bend or bends are inclined relative to the vertical when the chamber occupies one of said first and second positions;
the reaction chamber furthermore comprises a first tube, one end of which opens into the first conduit and the other end of which is outside the chamber;
the reaction chamber furthermore comprises an outer second tube, one end of which is connected to said first orifice, said tube occupying a vertical position above the first container in said first position of the chamber, and below the first container in the second position.

The invention relates in particular to a reaction chamber as defined above, in which said containers and said tubes and conduit form a closed assembly containing a first glass in the first container and a second glass, of different refractive index, in the second container.

The reaction chamber of the invention may be made of any material which is compatible with the cladding and core glasses being used, and which has a melting temperature higher than the softening temperature of said glasses. The material must be sufficiently inert in chemical terms so that it does not contaminate the cladding and core glasses beyond what is acceptable. The reaction chamber of the invention may, for example, be made of silica or pyrex glass.

Silica or pyrex glass have the advantage that they behave like normal glass, and that they allow the content of the chamber to be observed directly.

The invention also relates to a method for preparing a preform for optical fibers with a cladding glass and a core glass of different indices, or a corresponding optical fiber, with the aid of a reaction chamber as defined above. This method has, in particular, the following features:
the cladding glass is introduced into the first container and the core glass is introduced into the second container, the chamber occupying said first position or a similar position,
the chamber is evacuated,
the chamber is heated to a sufficient temperature for the two glasses to be liquid,
the chamber is rotated in the first predetermined direction from said first position to said second position, so that the cladding glass flows under gravity toward then through the first orifice,
the chamber is returned to said first position, and
after a predetermined time, the reaction chamber is rotated in said second predetermined direction, from the first position to the second position, so that the core glass which has remained liquid in the second container passes through the second orifice, enters the conduit, and reaches the open end through which it flows under gravity and passes through said first orifice.

The outer second tube as described above may, for example, be used in order to introduce the cladding glass into the first container. This outer tube is then sealed at a sufficient distance from the first orifice, and can then be used as a mold for the preform.

A first tube as described above may be used in order to introduce the core glass into the second container. This tube may then be sealed in an outer region close to the wall of the first container.

The cladding and core glasses may be introduced in the form of solid particles, for example.

The method of the invention is, in particular, a method in which:
after the chamber is rotated in said first predetermined direction, the cladding glass passes through the first orifice and fills said outer tube, while the core glass remains confined in the second container,
said outer tube is cooled for a predetermined time so that a part of the cladding glass close to the wall of the outer tube solidifies, while the part of the cladding glass in the axial region of the tube is still liquid,
the chamber is then returned from the second position to said first position, so that the part of the cladding glass which is still liquid flows under gravity into the first container, while the solidified part of the cladding glass remains in the tube, the axial part of which is empty,
after said rotation of the chamber in said second predetermined direction, the core glass which has remained liquid in the second container flows along the conduit then falls through the first orifice into the axial part of the tube,
and if so desired, the preform obtained in this way is converted into an optical fiber.

Particular embodiments of the invention will now be described in more detail with reference to the appended drawings, in which:

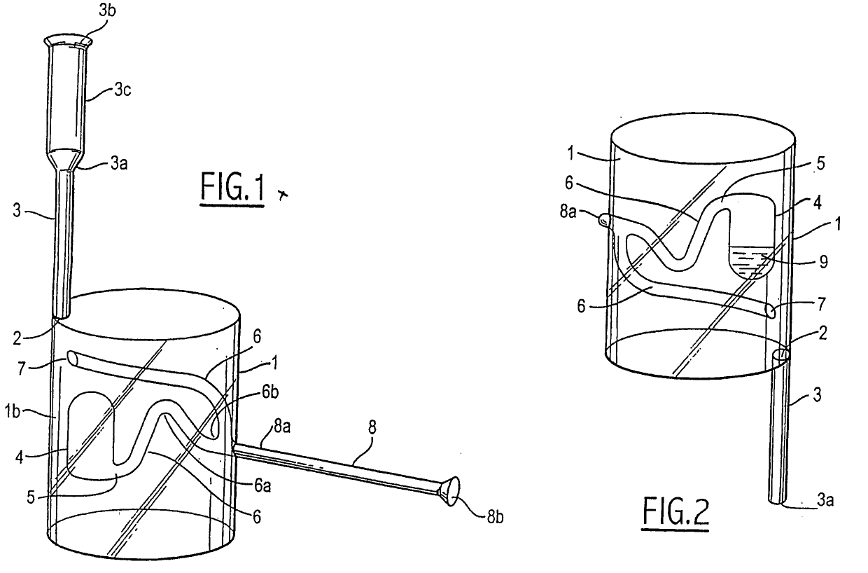

FIG. 1 represents a schematic perspective view of the chamber in the aforementioned first position,

FIG. 2 represents a schematic perspective view of the chamber in the second position.

As can be seen in FIG. 1, the reaction chamber of the invention comprises a first container 1 communicating with an outer tube 3 via an orifice 2.

The second container 4 communicates via an orifice 5 with one end of a conduit 6, the other end 7 of which is an open end. The end 7 is in the form of a spout oriented so that the unsolidified cladding glass coming from the centre of the tube 3 cannot obstruct or contaminate the conduit through which the core glass will be poured. A second conduit 8 communicates with the conduit 6 via one of its ends, and its other end located outside the chamber is an open end.

The reaction chamber of the invention is represented in FIG. 1 in the position referred to above as the “first position”, with the tube 3 meant to be vertical. It can be seen that the orifice 2 is in an upper position on the first container, while the orifice 5 is at a lower position of the wall of the second container.

The cladding glass is introduced in the form of solid particles through the orifice 3b, optionally while inclining the chamber slightly by counterclockwise rotation about an axis perpendicular to the plane of the drawing, so as to prevent the cladding glass from being introduced into the conduit 6 through the orifice 7. By increasing the angle of rotation, the end 8b of the tube 8 is raised and the core glass can then be introduced through the end 8b, whereupon it falls under gravity into the second container 4. The tube 8 is provided at 8b with a tap (not shown in the drawing). This tap is closed. The chamber is evacuated by connecting the tube 3 to a vacuum pump, after which the tube 8 is sealed at 8a then the tube 3 is sealed at the level 3a, as represented in FIG. 2.

It is of course possible to evacuate by means of another outer tube (not shown) which, for example, opens into the container 1, then seal the tubes 3 and 8 and lastly said other outer tube.

The second container 4/conduit 6 assembly may also be stiffened inside the first container 1 with the aid of stiffeners such as welded silica rods, for example joining the containers 1 and 4 or the conduit 6 and the container 1.

If such a rod extends outside the container 1, it may also be used as a handle.

FIG. 1 represents the chamber in its initial form, with the unsealed tubes 3 and 8 having an open end.

In FIG. 2, the reaction chamber of the invention has been represented in the position referred to above as the “second position”, with the tubes 3 and 8 sealed at 3a and 8a.

This second position can be reached from the first position after rotation through 180° about an axis perpendicular to the plane of the drawing.

As indicated above, the configuration of the chamber is such that when moving from the first position to the second position, a liquid present in the second container will either remain confined or alternatively flow in the conduit 6, depending on the direction of rotation. This is principally due to the upper position (in the first position of FIG. 1) of the orifice 5 in the second container 4, the effect of which is that when there is a liquid in the container 4, then the liquid will remain in the container 4 if said rotation of 180° from the first position (that of FIG. 1) is carried out in the counterclockwise direction. This liquid 9 has been represented in the container 4 of FIG. 2. If said rotation is carried out in the clockwise direction, however, then said liquid will flow in the conduit 6 and reach the orifice 7 and (the position is now as represented in FIG. 2) this liquid will flow vertically under gravity in the tube 3.

It is not necessary for the conduit 6 to have bends. Nevertheless, the presence of bends does lengthen time taken for the liquid core glass to flow to the open end 7 of the conduit 6, which allows this flow to be controlled better.

In order to prepare a preform, the cladding and core glasses are therefore introduced in a solid form, the vacuum is created, and sealing is carried out as indicated above.

The chamber is then put in an oven in the first position, which is that represented in FIG. 1. The chamber is heated to a sufficient temperature for the cladding and core glasses to be liquid. The cladding glass then collects in the lower part of 1a of the container 1. When a rotation of 180° is carried out in the counterclockwise direction, as indicated above, the cladding glass will flow along the wall 1b of the container 1 then reach the orifice 2 and fill the sealed tube 3. There is a sufficient quantity of the cladding glass to fill the tube 3 completely.

The tube 3 is then cooled, for example by immersing the tube in water, for a time such that only a peripheral part of the cladding glass is solidified, while the central part is still liquid. The cooling time depends on the respective thicknesses intended for the cladding and for the core part of the preform. This time will be determined beforehand by simple routine experiments. If thin cladding is desired, it may simply be left to cool for a sufficient time in air at room temperature.

Another rotation of about 180° is then carried out in order to return the chamber to the first position, this rotation preferably being carried out in the clockwise direction (although it may also be carried out in the counterclockwise direction owing to the viscosity of liquid glass, which makes it flow relatively slowly). In this new position, the unsolidified cladding glass coming from the centre of the tube 3 will flow along the walls of the container 1 and collect in the bottom of said container.

Another rotation of 180° is then carried out, this time in the clockwise direction, so that the core glass in the container 4 flows through the conduit 6, reaches the orifice 7 and then flows under the influence of the forces of gravity into the hollow part of the cladding formed in the tube 3.

During this last rotation, the excess cladding glass which has cooled during its stay in the tube 3 and during its return into the container 1 has a greatly increased viscosity, and this glass remains substantially stuck to the wall of the container 1 during the last rotation so that there is no risk that it could flow into the core of the preform.

Once the preform has been produced in this way, the entire assembly can be reintroduced into an oven for annealing, at a temperature close to the glass transition temperature of whichever out of the cladding and core glasses has the lower transition temperature, in order to reduce the internal stresses.

Single-mode or multimode optical fibers can then be prepared from the preforms obtained according to the invention, by using the known methods which will be summarized below. Particular examples of glasses which can be used as cladding or core glasses are:
glasses of the Te—As—Se, Ge—As—S or Ge—As—Se systems, such as those described by Z. U. Borisova, Glassy Semiconductors, Plenum Press, New York, 1981;
chalcogenide glasses such as those described in “Materials Science and Technology” (Cahn, Haasen, Kramer Eds.), Volume 9 (Glasses and Amorphous Materials);
the glasses based on gallium, germanium and antimony chalcogenides as described in Patent Application FR 97 14942 (Publication Number 2 771 405).

It can be seen in the appended drawings that the axis of the conduit 6 lies in the plane of the drawing, which is meant to be vertical. The conduit may have a bend close to the orifice 5, for example, so that the axis of the tube is in a plane perpendicular to the plane of the drawing, for example, after this bend. It is readily apparent that the second predetermined direction of rotation as mentioned above then corresponds to rotation about a horizontal axis lying in the plane of the drawing, while the first predetermined direction of rotation may correspond to rotation about a horizontal axis perpendicular to the plane of the drawing.

Certain glasses, such as Te—As—Se glasses, can be distilled in a vacuum. In order to introduce these glasses into their respective containers, it is thus possible to operate by vacuum distillation in the tubes 3 and 8. For example, the tube 3 sealed at 3b contains at the level 3c a closure cap (not shown) through which a small distillation tube extends, the solid cladding glass being contained in the part between 3b and 3c. This part is introduced into an oven, after having evacuated the chamber. The distillate collected in the lower part of the tube 3 (FIG. 1) flows into the first container. The tube 3 is then sealed at the level 3a, as described above. A similar procedure can be carried out in the tube 8 for the core glass.

An example of producing a preform will now be given.

### EXAMPLE

A silica reaction chamber similar to that in the FIG. 1 was prepared.

The container 1 has a diameter of 60 mm and a height of 60 mm. The tube 3 has a height of 190 mm, and 90 mm after sealing at the level 3a. The container 4 has a diameter of 15 mm. The outer part of the tube 8 has a length of 100 mm.

The cladding glass (25 g) has the following composition (expressed in atoms): Te₂As₃Se₅.

The cladding glass (12 g) has the following composition: Te_{2.5}As₃Se_{4.5}.

After introducing the glasses into their respective containers, the tube 8 is sealed at 8a, the vacuum is established via the tube 3, and the tube 3 is sealed at 3a. The chamber is heated to 500° C. in the oven for about 1 hour. The chamber is removed from the oven in the first position. At time t₀, a rotation of 180° is carried out in the counterclockwise direction. The cladding glass fills the tube 3. At time t₀+15 s, the tube 3 is immersed in water. The tube is removed from the water at time t₀+25 s and the chamber is subjected to another rotation of 180°, in the clockwise direction. The centre of the tube 3 empties, but a solidified glass cladding remains at the inner periphery.

Another rotation of 180° is carried out at time t₀+45 s, in the clockwise direction. The liquid core glass flows in the conduit 6, reaches the spout 7 and fills the hollow part of the tube 3. All of the molding is then annealed at a temperature lower than Tg (glass transition temperature). The end of the tube 3 is broken and the preform is extracted. Studying the composition along a diameter of a cross section by electron microscopy shows a constant arsenic content, with tellurium increasing and selenium decreasing in the core of the preform.

1. A reaction chamber comprising:
a first container consisting essentially of a wall delimiting a volume which is substantially closed, apart from at least one first orifice formed in said wall,
a second container consisting essentially of a wall delimiting a volume which is substantially closed, apart from a second orifice connecting the second container to a first end of a conduit having an open second end,
in which:
said first and second containers are integral,
said second container and said conduit are integral,
said open second end is inside the first container,
said chamber being capable of occupying two positions, namely
a first position in which said first orifice is in an upper position relative to the other parts of the first container, and said second orifice is in a lower position relative to the other parts of the second container, and
a second position in which said first orifice is in a lower position relative to the other parts of the first container, said second orifice being in an upper position relative to the other parts of the second container, and said open end of the conduit is aligned with and at a distance from said first orifice, and the configuration of said chamber being such that when the chamber is rotated in a first predetermined direction from said first position to said second position, any liquid contained in said second container remains in the second container without being able to flow through said conduit to said open end, and when the chamber is rotated in a second predetermined direction, from said first position to said second position, any liquid contained in said second container flows through said conduit and reaches said open end.

2-13. (canceled)

14. The reaction chamber as claimed in claim 1, in which said second container and the conduit are inside the first container.

15. The reaction chamber as claimed in claim 1, in which said conduit has at least one bend.

16. The reaction chamber as claimed in claim 15, in which said conduit comprises a system of two bends in the shape of a Z.

17. The reaction chamber as claimed in claim 1, in which said conduit comprises a first part from the orifice of the second container to a first bend at a distance from the second orifice, a second part from the first bend to a second bend, then a third part from the second bend to the open end, and in which, in said first position, said first bend occupies an upper position relative to the second orifice and said second end occupies a lower position relative to said first bend.

18. The reaction chamber as claimed in claim 16, in which the branches of the bend or bends are inclined relative to the vertical in said first and second positions of said chamber.

19. The reaction chamber as claimed in claim 17, in which the branches of the bend or bends are inclined relative to the vertical in said first and second positions of said chamber.

20. The reaction chamber as claimed in claim 1, further comprising a first outer tube, one end of which is connected to said first orifice, said tube occupying a vertical position above the first container in said first position of the chamber, and below the first container in the second position.

21. The reaction chamber as claimed in claim 20, further comprising a second tube, one end of which opens into the first conduit and the other end of which is outside the chamber, said second tube being sealable in its part outside the chamber.

22. The reaction chamber as claimed in claim 21, in which said containers and said tubes and conduit form a closed assembly containing a first glass in the first container and a second glass, of different index, in the second container.

23. The reaction chamber as claimed in claim 22, in which said containers, conduit, and tubes are made of silica or pyrex glass.

24. A method for preparing an optical fiber preform or an optical fiber with a cladding glass and a core glass, of different indices, with the aid of a reaction chamber, the reaction chamber comprising:
a first container consisting essentially of a wall delimiting a volume which is substantially closed, apart from at least one first orifice formed in said wall,
a second container consisting essentially of a wall delimiting a volume which is substantially closed, apart from a second orifice connecting the second container to a first end of a conduit having an open second end,
in which:
said first and second containers are integral,
said second container and said conduit are integral,
said open second end is inside the first container, said chamber being capable of occupying two positions, namely
a first position in which said first orifice is in an upper position relative to the other parts of the first container, and said second orifice is in a lower position relative to the other parts of the second container, and
a second position in which said first orifice is in a lower position relative to the other parts of the first container, said second orifice being in an upper position relative to the other parts of the second container, and said open end of the conduit is aligned with and at a distance from said first orifice, and the configuration of said chamber being such that when the chamber is rotated in a first predetermined direction from said first position to said second position, any liquid contained in said second container remains in the second container without being able to flow through said conduit to said open end, and when the chamber is rotated in a second predetermined direction, from
said first position to said second position, any liquid contained in said second container flows through said conduit and reaches said open end;
the method comprising:
introducing the cladding glass into the first container and the core glass into the second container, the chamber occupying said first position or a similar position,
evacuating the chamber,
heating the chamber to a sufficient temperature for the two glasses to be liquid,
rotating the chamber in the first predetermined direction, from said first position to said second position, so that the cladding glass flows under gravity toward then through the first orifice,
returning the chamber to said first position, and
after a predetermined time, rotating the reaction chamber in said second predetermined direction, from the first position to the second position, so that the core glass which has remained liquid in the second container passes through the second orifice, enters the conduit, and reaches the open end through which it flows under gravity and passes through said first orifice.

25. The method as claimed in claim 24, wherein the chamber further comprises a first outer tube, one end of which is connected to said first orifice, said tube occupying a vertical position above the first container in said first position of the chamber, and below the first container in the second position.

26. The method as claimed in claim 25, in which:
after rotating the chamber in said first predetermined direction, the cladding glass passes through the first orifice and fills said outer tube, while the core glass remains confined in the second container, and
the method further comprises:
cooling said outer tube for a predetermined time so that a part of the cladding glass close to the wall of the outer tube solidifies, while the part of the cladding glass in the axial region of the tube is still liquid,
returning the chamber from the second position to said first position, so that the part of the cladding glass which is still liquid flows under gravity into the first container, while the solidified part of the cladding glass remains in the tube, the axial part of which is empty,
wherein after rotating the chamber in said second predetermined direction, the core glass which has remained liquid in the second container flows along the conduit then falls through the first orifice into the axial part of the tube, and
optionally converting the obtained preform into an optical fiber.
